(19) United States
(12) Patent Application Publication
(10) Pub. No.: US 2018/0365605 A1
(43) Pub. Date: Dec. 20, 2018

(54) SUPPLY CHAIN SIMULATION SYSTEM AND SUPPLY CHAIN SIMULATION METHOD

(71) Applicant: Hitachi, Ltd., Tokyo (JP)

(72) Inventors: Yoshiki KUROKAWA, Tokyo (JP); Hiroki MIYAMOTO, Tokyo (JP); Yoshiteru TAKESHIMA, Tokyo (JP); Toshihiko KASHIYAMA, Tokyo (JP)

(21) Appl. No.: 15/921,750

(22) Filed: Mar. 15, 2018

(30) Foreign Application Priority Data
Jun. 16, 2017 (JP) 2017-118829

(51) Int. Cl. G06Q 10/06; G06Q 10/08

(52) U.S. Cl. CPC G06Q 10/067; G06Q 10/06375; G06Q 10/08

(57) ABSTRACT

To shorten the simulation time without deteriorating the simulation accuracy. In a supply chain simulation system which performs simulation of a supply chain, a simulation data dividing unit creates a plurality of simulation divided input data obtained by consolidating and classifying, based on the transport-related information of each of the divided groups, simulation input data related to products of the plurality of items for each item in which the transport-related information of each of the divided groups are closely related to each other, and a plurality of simulators individually execute division simulation based on the plurality of simulation divided input data.

### TECHNICAL FIELD

The present invention relates to a supply chain simulation system and a supply chain simulation method, and in particular can be suitably applied to a supply chain simulation system related to a supply chain simulation technology.

### BACKGROUND ART

Conventionally, the time required for supply chain simulation was shortened by visualizing evaluation indexes related to SCM (Supply Chain Management) inventory management, and selecting the target inventory requiring improvement measures (hereinafter also referred to as the “simulation target”) (refer to PTL 1).

### CITATION LIST

### Patent Literature

PTL 1: Japanese Unexamined Patent Application Publication No. 2007-26335

### SUMMARY OF THE INVENTION

### Problems to be Solved by the Invention

Nevertheless, according to the conventional technology described above, there was a problem in that, when the simulation target is narrowed down, the simulation accuracy will deteriorate on the one hand, and, in order to comprehend the overall inventory while maintaining the simulation accuracy, the simulation of all items is required, but then much simulation time also becomes required.

The present invention was devised in view of the foregoing points, and an object of this invention is to propose a supply chain simulation system and a supply chain simulation method capable of shortening the simulation time without deteriorating the simulation accuracy.

### Means to Solve the Problems

In order to achieve the foregoing object, the present invention provides a supply chain simulation system which performs simulation of a supply chain in which products of a plurality of items are each transported by a plurality of transport systems via a plurality of warehouses, comprising: a simulation data dividing unit which sets each divided group by classifying the products of the plurality of items according to whether or not a distribution channel matches for each of the products of the plurality of items, calculates transport-related information of each of the divided groups based on an allocation ratio calculated for each of the divided groups, and creates a plurality of simulation divided input data obtained by consolidating and classifying, based on the transport-related information of each of the divided groups, simulation input data related to the products of the plurality of items for each item in which the transport-related information of each of the divided groups are closely related to each other; a plurality of simulators which individually execute division simulation based on the plurality of simulation divided input data; a simulation result aggregation unit which generates simulation aggregate result data by aggregating a plurality of simulation division execution result data representing results of simulations respectively performed by the plurality of simulators; and a result display unit which displays an overall result of the simulation based on the simulation aggregate result data.

The present invention additionally provides a supply chain simulation method of performing simulation of a supply chain in which products of a plurality of items are each transported by a plurality of transport systems via a plurality of warehouses, comprising: a simulation data division step in which a computer sets each divided group by classifying the products of the plurality of items according to whether or not a distribution channel matches for each of the products of the plurality of items, calculates transport-related information of each of the divided groups based on an allocation ratio calculated for each of the divided groups, and creates a plurality of simulation divided input data obtained by consolidating and classifying, based on the transport-related information of each of the divided groups, simulation input data related to the products of the plurality of items for each item in which the transport-related information of each of the divided groups are closely related to each other; a simulation step in which a plurality of simulators individually execute division simulation based on the plurality of simulation divided input data; a simulation result aggregation step in which the computer generates simulation aggregate result data by aggregating a plurality of simulation division execution result data representing results of simulations respectively performed by the plurality of simulators; and a result display step in which the computer displays an overall result of the simulation based on the simulation aggregate result data.

### Advantageous Effects of the Invention

According to the present invention, it is possible to shorten the simulation time without deteriorating the simulation accuracy.

### BRIEF DESCRIPTION OF DRAWINGS

FIG. 1 is a block diagram showing a schematic configuration of the supply chain simulation system according to the first embodiment.

FIG. 2 is a diagram showing an example of the table configuration of the item master.

FIG. 3 is a diagram showing an example of the table configuration of the inventory performance table.

FIG. 4 is a diagram showing an example of the table configuration of the transport performance table.

FIG. 5 is a diagram showing an example of the table configuration of the warehouse information table.

FIG. 6 is a diagram showing an example of the table configuration of the transport information table.

FIG. 7 is a diagram showing an example of the simulation data division processing performed by the simulation data dividing unit 110.

FIG. 8 is a diagram showing an example of the divided group generation processing of the items shown in FIG. 7.

FIG. 9 is a diagram showing an example of the warehouse capacity division processing shown in FIG. 7.

FIG. 10 is a diagram showing an example of the maximum transport volume calculation processing shown in FIG. 7.

FIG. 11 is a block diagram showing a configuration example of the supply chain simulation system according to the second embodiment.

FIG. 12 is a diagram showing an example of the simulation data division processing according to the second embodiment.

FIG. 13 is a diagram showing an example of the new warehouse capacity division processing.

FIG. 14 is a diagram showing an example of the setting screen.

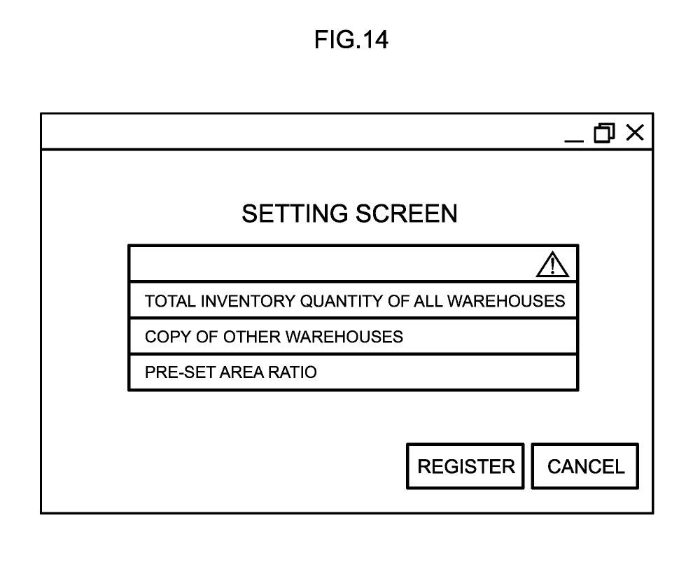

### DESCRIPTION OF EMBODIMENTS

An embodiment of the present invention is now explained in detail with reference to the appended drawings. In this embodiment, when performing division based on items, because the capacity of a warehouse having an inventory and the capacity of a transport means having a transport volume will appear to be greater than the actual capacity, division simulation is applied by calculating the capacity based on the distribution ratio, which is calculated from performance data of the inventory quantity and the transport volume, and it is thereby possible to perform simulation without deteriorating the accuracy. This is now explained in detail.

### (1) First Embodiment

### (1-1) Configuration Example of Supply Chain Simulation System

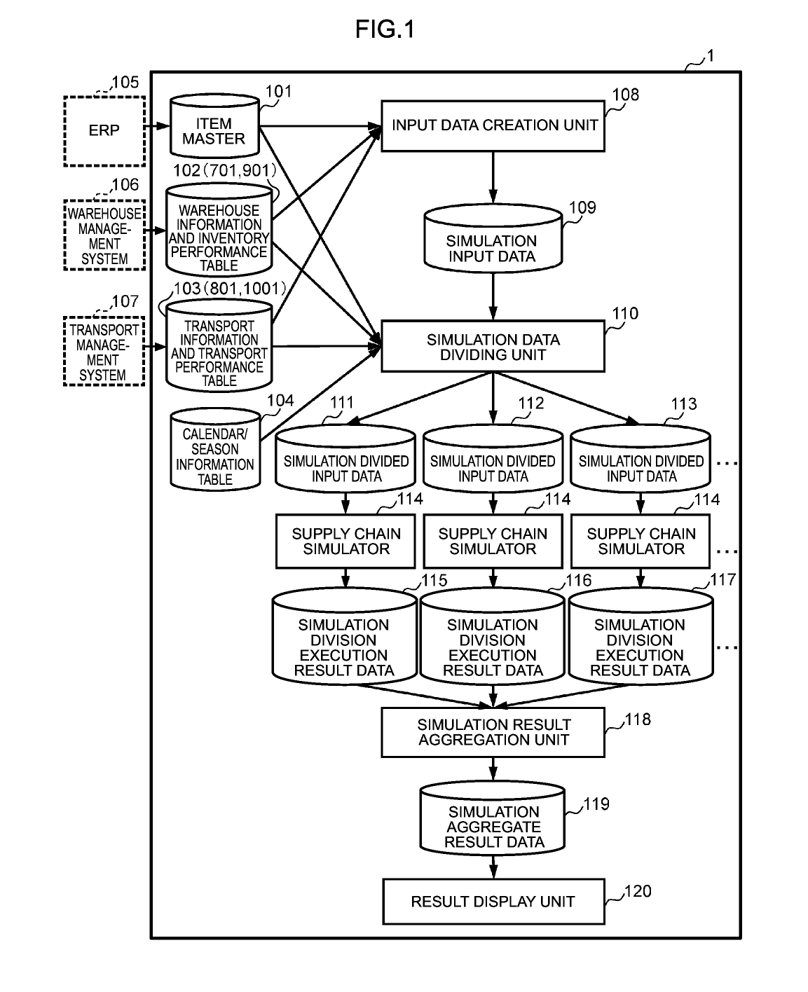

FIG. 1 is a block diagram showing the overall configuration example of a supply chain simulation system 1 according to the first embodiment.

The supply chain simulation system 1 is, for example, a computer comprising an input data creation unit 108, a simulation data dividing unit 110, a supply chain simulator 114, a simulation result aggregation unit 118, and a result display unit 120, as well as an item master 101, a warehouse information and inventory performance table 102, a transport information and transport performance table 103, and a calendar/season information table 104.

The input data creation unit 108 creates the overall simulation input data 109. The simulation data dividing unit 110 has a function of dividing the simulation input data 109 into simulation divided input data 111, 112, 113 in a plurality of item units. Details of the input data creation unit 108 will be described later.

Three supply chain simulators 114 have a function of individually performing simulation (this is also hereinafter referred to as the “division simulation”) based on the simulation divided input data 111, 112, 113, and respectively generating simulation division execution result data 115, 116, 117. Details of the supply chain simulator 114 will be described later.

The simulation result aggregation unit 118 has a function of merging the simulation division execution result data 115, 116, 117 and generating simulation aggregate result data 119. Details of the simulation result aggregation unit 118 will be described later.

The result display unit 120 has a function of displaying the overall simulation result based on the simulation aggregate result data 119.

An ERP 105 is a backbone information system, and uses the item master 101 which manages information related to the handled items.

The warehouse management system 106 is an information system which manages warehouses, and, for instance, handles the basic information of warehouses and the inventory status of warehouses.

The transport management system 107 is a system which manages the overall transport, and, for instance, handles the basic information and transport performance of transport systems.

The item master 101 manages the master data of items handled in the supply chain. The item master 101 is a table which includes, for instance, an item code column, an item size column, an item weight column and other information. The foregoing information of the item master 101 is acquired by the ERP 105. Details of the item master 101 will be described later.

The warehouse information and inventory performance table 102 manages information related to warehouses of the supply chain. This information is configured from warehouse information (corresponds to information of the warehouse information table described later) and inventory performance (corresponds to information of the inventory performance table described later). The warehouse information is information related to the warehouse to be simulated within the supply chain. The warehouse information and inventory performance table 102 is a table which includes, for instance, a warehouse code column, a warehouse capacity column and other information. Meanwhile, the inventory performance exists for each warehouse, and the quantity of inventory performance of the relevant warehouse in the past is managed for each item and each date. The foregoing information of the warehouse information and inventory performance table 102 is acquired from the warehouse management system 106. Details of the warehouse information and inventory performance table 102 will be described later.

The transport information and transport performance table 103 manages information related to the transport of the supply chain. This information is configured from transport information (corresponds to information of the transport information table described later) and transport performance (corresponds to information of the transport performance table described later). The transport information is information related to the transport to be simulated within the supply chain. The transport information and transport performance table 103 is a table which includes, for instance, a transport system code column and a maximum transport volume column. Meanwhile, the transport performance exists for each transport system, and the quantity of shipping performance of the carrier in the past is managed for each item and each data. The foregoing information of the transport information and transport performance table 103 is acquired from the transport management system 107. Details of the transport information and transport performance table 103 will be described later.

The calendar/season information table 104 is information related to the time of the supply chain. This information is configured from calendar/season information. Because the inventory performance and the shipping performance of the supply chain fluctuate considerably depending on seasonal factors, the calendar/season information is required. The calendar is information related to the business days of the respective companies (factories, warehouses, carriers and the like) related to the supply chain. Meanwhile, the season information represents the current phase within the year.

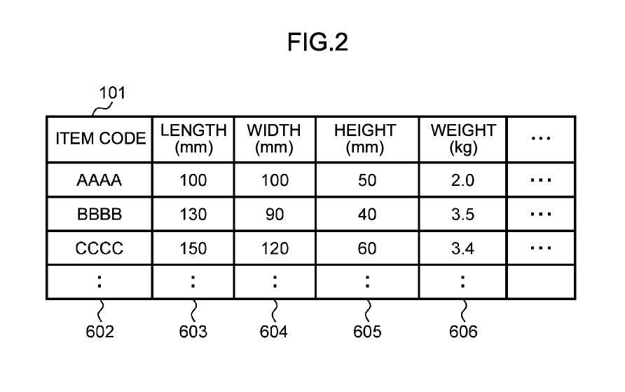

FIG. 2 shows an example of the table configuration of the item master 101 illustrated in FIG. 1.

The item master 101 is a table having an item code 602 as the key, and includes, in addition to the item code 602, columns such as length 603, width 604, height 605, and weight 606 as information related to the size of the item.

The item code 602 is a column that is used as the key of the item master 101, and represents codes capable of mutually distinguishing a plurality of items and which do not mutually overlap in such items. The length 603 represents the measurement of the length of the item. The width 604 represents the measurement of the width of the item. The height 605 represents the height of the item. The weight 606 represents the weight of the item.

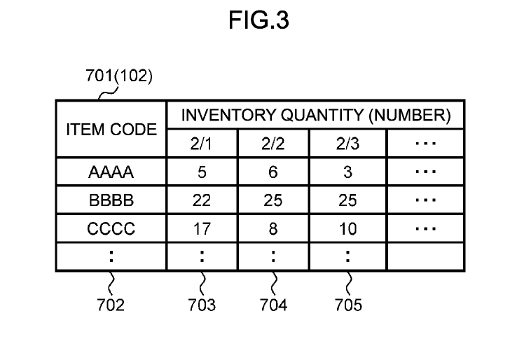

FIG. 3 shows an example of the table configuration of the inventory performance table 701. The inventory performance table 701 configures a part of the foregoing warehouse information and inventory performance table 102, and retains the inventory quantity (number) for each item on each date in the target warehouse.

The item code 702 is a column that is used as the key of the inventory performance table 701, and represents codes capable of mutually distinguishing a plurality of items and which do not mutually overlap in such items. With regard to the inventory quantities 703, 704, 705 of the respective dates, for instance, reference numeral 703 represents the inventory quantity of February 1, reference numeral 704 represents the inventory quantity of February 2, and reference numeral 705 represents the inventory quantity of February 3. Here, while three days' worth of inventory quantities were illustrated, let it be assumed that the inventory quantities of the past several months to past several years are being retained.

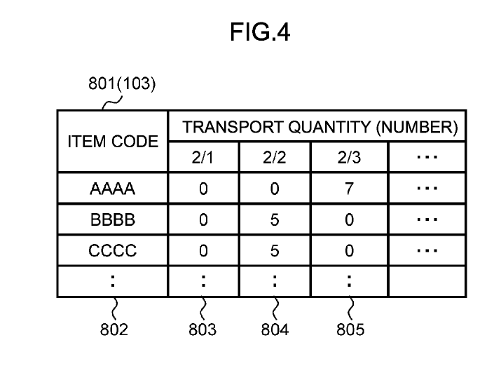

FIG. 4 shows an example of the table configuration of the transport performance table 801.

The transport performance table 801 configures a part of the foregoing transport information and transport performance table 103, and retains the shipping quantity (number) for each item on each date in the target carrier. The item code 802 is a column that is used as the key of the transport performance table 801, and represents codes capable of mutually distinguishing a plurality of items and which do not mutually overlap in such items.

With regard to the shipping quantities 803, 804, 805 of the respective dates, for instance, reference numeral 803 represents the shipping quantity of February 1, reference numeral 804 represents the shipping quantity of February 2, and reference numeral 805 represents the shipping quantity of February 3. Here, while three days' worth of shipping quantities were illustrated, let it be assumed that the shipping quantities of the past several months to past several years are being retained.

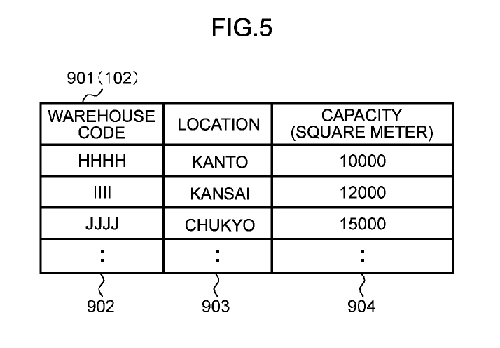

FIG. 5 shows an example of the table configuration of the warehouse information table 901. The warehouse information table 901 configures a part of the foregoing warehouse information and inventory performance table 102, and is a table which manages information related to the warehouse to be subject to division simulation. Division simulation is performed based on this information.

The warehouse code 902 is a column that is used as the key of the warehouse information table 901, and represents codes capable of mutually distinguishing a plurality of warehouses and which do not mutually overlap in such warehouses. The location 903 represents the address of the warehouse, and the capacity 904 represents the capacity of the warehouse.

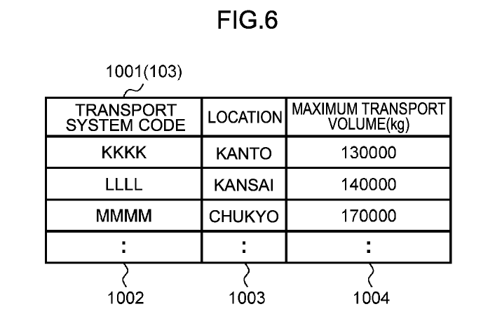

FIG. 6 shows an example of the table configuration of the transport information table 1001. The transport information table 1001 configures a part of the foregoing transport information and transport performance table 103, and is a table regarding the transport system to be subject to division simulation. Division simulation is performed based on this information.

The transport system code 1002 is a column that is used as the key of the transport information table 1001, and represents codes capable of mutually distinguishing a plurality of transport systems and which do not mutually overlap in such transport systems. The location 1003 represents the address of the transport system, and the maximum transport volume 1004 represents the maximum transport volume of the transport system.

### (1-2) Operational Example of Supply Chain Simulation System

The overview of the configuration of the supply chain simulation system 1 according to the first embodiment is as described above, and an operational example thereof is now explained.

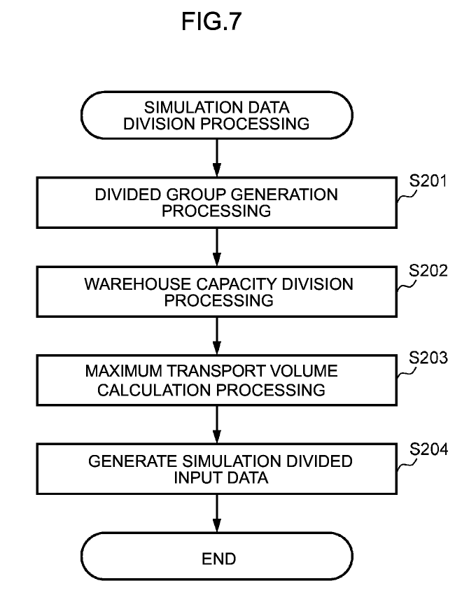

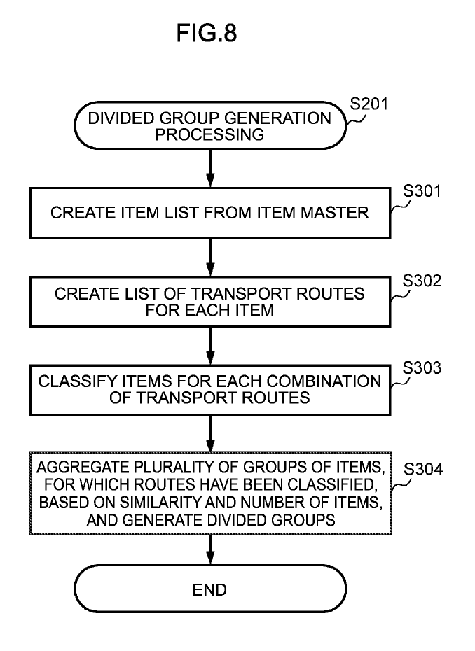

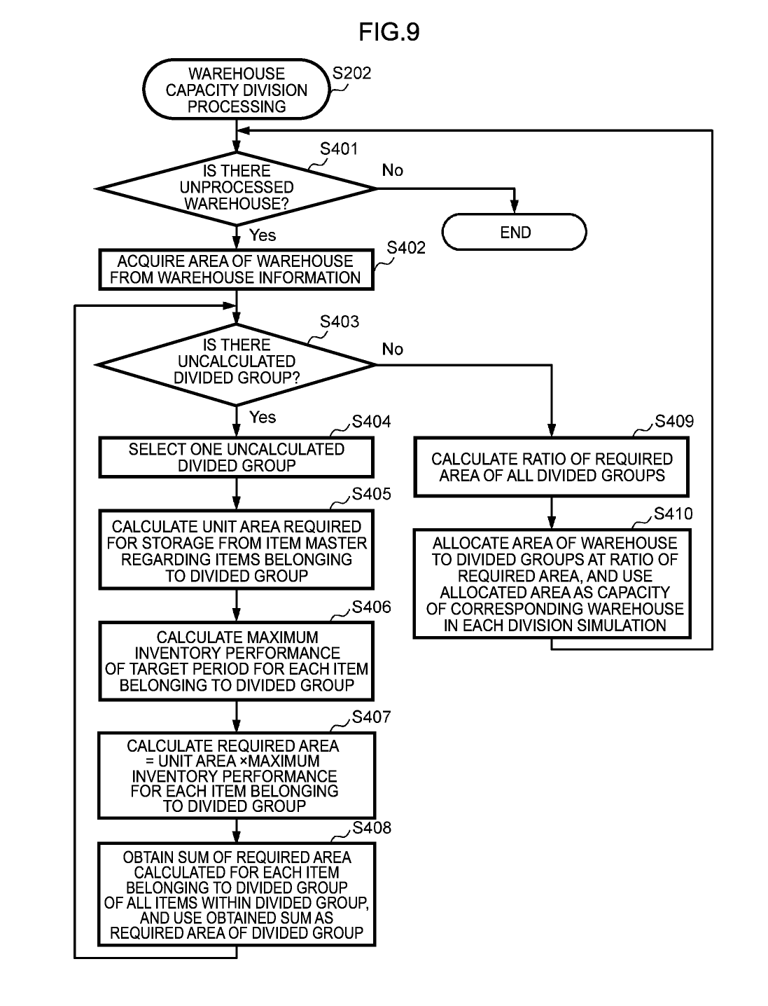

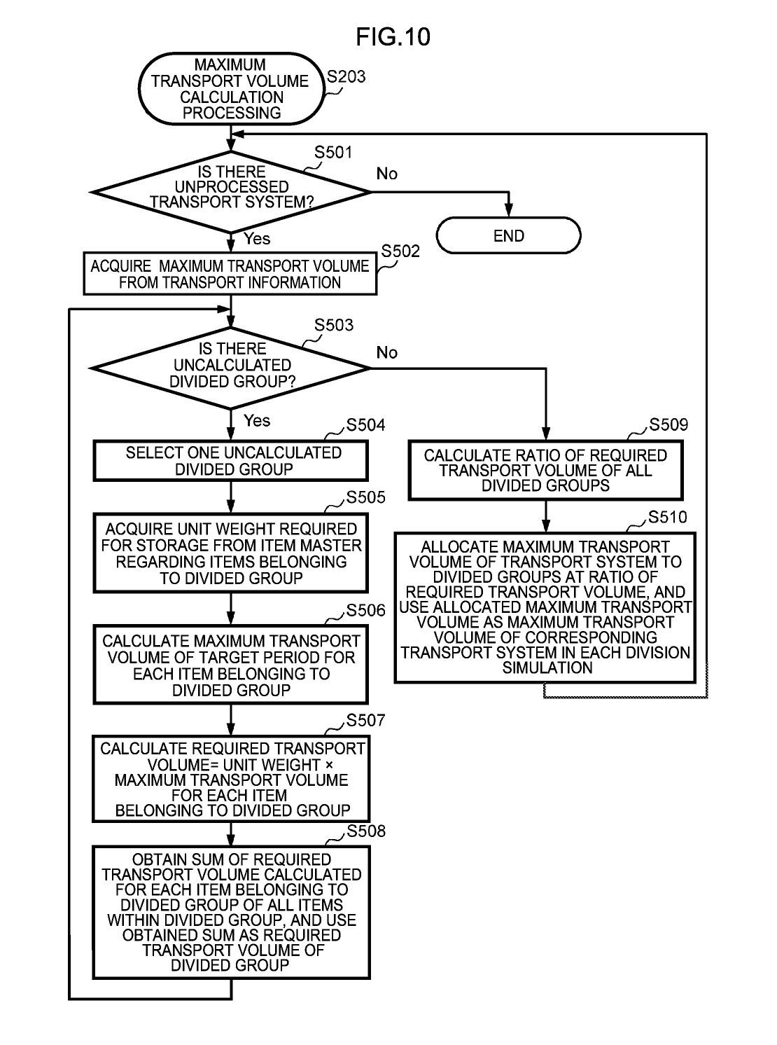

FIG. 7 shows an example of the simulation data division processing performed by the simulation data dividing unit 110. FIG. 8 shows an example of the divided group generation processing as step S201 illustrated in FIG. 7. FIG. 9 shows an example of the warehouse capacity division processing as step S202 illustrated in FIG. 7. FIG. 10 shows an example of the maximum transport volume calculation processing as step S203 illustrated in FIG. 7.

Foremost, with reference to FIG. 7, in order to divide the simulation data as described above, the simulation data dividing unit 110 refers to the item master 101 and extracts an item information group, and additionally refers to the transport information and transport performance table 103 and identifies the transport route which is used for distributing the respective items corresponding to the respective item information. The simulation data dividing unit 110 groups the plurality of items having the same transport route among the respective items, and uses the grouping result as the divided group (step S201 of FIG. 7).

More specifically, the simulation data dividing unit 110 refers to the item master 101 and creates an item list (step S301 of FIG. 8). The simulation data dividing unit 110 refers to the transport information and transport performance table 103 and identifies the transport route of the respective items on the item list created in step S301, and creates a transport route list (step S302 of FIG. 8).

Based on the created transport route list, the simulation data dividing unit 110 classifies the items for each combination of transport routes regarding all existing transport routes (step S303 of FIG. 8). The reason why the items are classified as described above is to separate items having mutually unrelated transport routes so that they can be subject to simulation later.

The simulation data dividing unit 110 confirms the degree of coincidence of transport routes regarding the classification of items for each combination of transport routes; that is, for example, confirms whether the transport containers are the same, respectively aggregates the plurality of item classifications to attain the number of items which should belong to the predetermined divided group, and thereby generates a plurality of divided groups (step S304 of FIG. 8).

Next, with reference to FIG. 7, the simulation data dividing unit 110 refers to the warehouse information and inventory performance table 102 and comprehends the warehouse group to be simulated, and additionally refers to the calendar/season information table 104 regarding the respective warehouses and extracts the inventory performance regarding the obtained period, and obtains the maximum value of the inventory (step S202 of FIG. 7).

The simulation data dividing unit 110 refers to the item master 101 and acquires the size information of the item, and calculates how much warehouse area is used during the foregoing inventory maximum value (step S202 of FIG. 7). The simulation data dividing unit 110 calculates the used warehouse area regarding all items handled in the warehouse, and totals the used warehouse area for each divided group (step S202 of FIG. 7). The simulation data dividing unit 110 divides the capacity of the warehouse at the ratio of the sum for each divided group, and the result is used as the warehouse capacity during the division simulation of each divided group (step S202 of FIG. 7).

To more specifically explain step S202 described above, the simulation data dividing unit 110 foremost refers to the warehouse information and inventory performance table 102 and determines whether or not there is any remaining unprocessed warehouse (step S401 of FIG. 9). The simulation data dividing unit 110 executes following step S402 when there is a remaining unprocessed warehouse, and determines the allocation ratio of the warehouse capacity when there is no remaining unprocessed warehouse; that is, ends this processing because all warehouse capacities have been determined.

Subsequently, the simulation data dividing unit 110 refers to the warehouse information and inventory performance table 102 and acquires the area of the target warehouse (step S402 of FIG. 9). The simulation data dividing unit 110 determines whether the required group described later exists in the uncalculated divided group among the divided groups that are being handled in the warehouse (step S403 of FIG. 9). The simulation data dividing unit 110 executes the processing related to the uncalculated divided group from step S404 as follows when there is an uncalculated divided group, and executes the calculation processing of the warehouse capacity from step S409 described later when there is no uncalculated divided group.

Foremost, the simulation data dividing unit 110 selects one uncalculated divided group (step S404 of FIG. 9). Next, the simulation data dividing unit 110 acquires the size information from the item master 101 regarding the item belonging to the one divided group selected in step S404, and calculates the unit area required for housing one of those items (step S405 of FIG. 9).

Next, the simulation data dividing unit 110 refers to the warehouse performance and inventory performance table 102 and the calendar information and season information table 104 regarding the items belonging to the divided group, and calculates the maximum inventory value based on the inventory performance of the target period (step S406 of FIG. 9).

Next, the simulation data dividing unit 110 calculates the required area using the following formula for each item regarding the items belonging to the divided group (step S407 of FIG. 9).

Required area=unit area×maximum inventory performance

Note that the unit area is calculated in step S405 above, and the maximum inventory performance is calculated in step S406 above.

Next, the simulation data dividing unit 110 totals the required areas calculated in step S407 regarding the items belonging to the divided group, and uses the calculation result as the required area of the divided group (step S408 of FIG. 9). After the processing, the simulation data dividing unit 110 returns to step S403 and continues the processing.

Next, because the required areas of all divided groups have been calculated in step S408 above, the simulation data dividing unit 110 calculates the ratio of such required areas (step S409 of FIG. 9).

Next, the simulation data dividing unit 110 distributes the area of the target warehouse at the ratio of the required areas in step S409, and uses the result as the warehouse capacity of that warehouse in the division simulation in the respective divided groups (step S410 of FIG. 9). After the processing, the simulation data dividing unit 110 returns to step S401 described above, and continues the processing.

As a result of performing the foregoing process, it is possible to inhibit the warehouse capacity from being handled to be greater than the actual warehouse capacity upon performing the division simulation, and inhibit the simulation accuracy from deteriorating.

The simulation data dividing unit 110 extracts the transport system to be simulated from the transport information, additionally extracts the transport performance of each transport system for the period obtained from the calendar information, and thereby obtains the maximum value of transport (step S203 of FIG. 7). The simulation data dividing unit 110 refers to the item master 101 and acquires the weight information of the item, and calculates the amount of transport means required during the foregoing maximum transport volume (step S203 of FIG. 7). The simulation data dividing unit 110 calculates the used transport weight for all items handled in the transport system, and totals the used transport weight for each divided group (step S203 of FIG. 7). The simulation data dividing unit 110 divides the transport performance at the ratio of the total value for each divided group, and uses the result as the maximum transport volume during the simulation of each divided group (step S203 of FIG. 7).

To more specifically explain step S203 of FIG. 7, the simulation data dividing unit 110 foremost determines whether or not there is any remaining unprocessed transport system from the transport information 103 (step S501 of FIG. 10). The simulation data dividing unit 110 executes step S502 described below when there is a remaining unprocessed transport system, and determines the allocation ratio of the transport capacity when there is no remaining unprocessed transport system; that is, ends this processing because all transport systems have been decided.

The simulation data dividing unit 110 refers to the transport information and transport performance table 103 and acquires the maximum transport volume of the target transport system (step S502 of FIG. 10). Next, the simulation data dividing unit 110 determines whether or not the required transport volume described later exists in an uncalculated divided group among the divided groups being handled by the transport system (step S503 of FIG. 10).

The simulation data dividing unit 110 performs the processing of the uncalculated divided group from step S504 described later when there is an uncalculated divided group, and executes the maximum transport volume calculation processing of the transport system from step S509 described later when there is no uncalculated divided group.

The simulation data dividing unit 110 selects one uncalculated divided group when there is an uncalculated divided group (step S504 of FIG. 10). The simulation data dividing unit 110 acquires the weight information from the item master 101 regarding the items belonging to the divided group selected in step S504 described above (step S505 of FIG. 10).

The simulation data dividing unit 110 acquires the transport performance and the calendar/season information regarding the items belonging to the divided group, and calculates the maximum transport volume from the transport performance of the target period (step S506 of FIG. 10).

The simulation data dividing unit 110 calculates the required transport volume using the following formula for each item regarding the items belonging to the divided group (step S507 of FIG. 10).

Required transport volume=unit weight×maximum transport volume

Note that the unit weight is calculated in step S505, and the maximum transport volume is calculated in step S506.

The simulation data dividing unit 110 totals the required transport volumes calculated in step S507 described above regarding the items belonging to the divided group, and uses the result as the required transport volume of the divided group (step S508 of FIG. 10). After the processing, the simulation data dividing unit 110 returns to and performs the processing of step S503 described above.

Meanwhile, when there is an uncalculated divided group, because the required transport volumes of all divided groups have been calculated in step S508, the simulation data dividing unit 110 calculates the ratio of the required transport volumes (step S509 of FIG. 10).

The simulation data dividing unit 110 distributes the maximum transport volume of the target carrier based on the ratio of the required transport volume, and uses the result as the maximum transport volume of the transport system in the division simulation of the respective divided groups (step S510 of FIG. 10). After the processing, the simulation data dividing unit 110 returns to and executes the processing of step S501 described above.

As a result of performing the foregoing process, it is possible to inhibit the maximum transport volume of the transport system from being handled to be greater than the actual maximum transport volume of the transport system upon performing the division simulation, and inhibit the simulation accuracy from deteriorating.

The simulation data dividing unit 110 creates simulation input data for each divided group by using the divided warehouse capacity and the divided maximum transport volume in the respective divided groups calculated in steps S202, S203 described above, and outputs the simulation divided input data 111, 112, 113. Note that the simulation data dividing unit 110 may also create simulation input data for each divided group by using one of either the divided warehouse capacity or the divided maximum transport volume in the respective divided groups calculated in either step S202 or step S203 described above, and output the simulation divided input data 111, 112, 113.

Three supply chain simulators 114 have a function of performing simulation based on the simulation divided input data 111, 112, 113, and respectively generating simulation division execution result data 115, 116, 117.

The simulation result aggregation unit 118 has a function of aggregating the simulation division execution result data 115, 116, 117, and generating the simulation aggregate result data 119. Here, because the simulation division execution result data 115, 116, 117 are mutually classified for each item, the simulation result aggregation unit 118 does not require complex aggregation processing, and the simple aggregation of the simulation division execution result data 115, 116, 117 will be sufficient.

The result display unit 120 displays the simulation result based on the simulation aggregate result data 119.

### (1-3) Effect of this Embodiment

According to the embodiment described above, the simulation accuracy will not deteriorate because, consequently, all items are substantially simulated, and the simulation time can be shortened because not much time is required for the foregoing aggregation processing.

### (2) Second Embodiment

### (2-1) Configuration Example of Supply Chain Simulation System

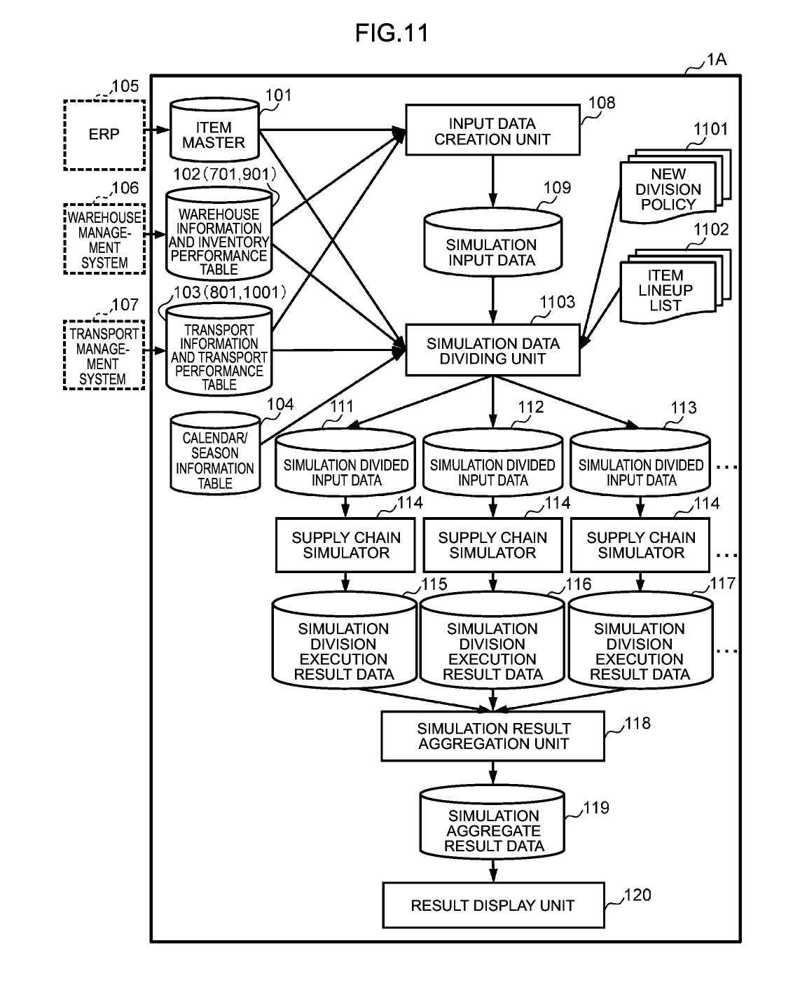

FIG. 11 shows a configuration example of the supply chain simulation system according to the second embodiment.

In the second embodiment, because the configuration and operation are basically the same as the first embodiment excluding the certain parts described later, explanation regarding the same configuration and operation will be omitted, and the differences between the first embodiment and the second embodiment will be mainly explained.

In the second embodiment, upon simulating the supply chain, unlike the first embodiment, assumed is a case where a new warehouse is added to the current supply chain upon performing the simulation.

In the second embodiment, in comparison to the first embodiment, a new dividing policy 1101 and an item lineup list 1102 are newly added, and additionally a simulation data dividing unit 1103 shown in FIG. 11 is provided in substitute for the simulation data dividing unit 110 (refer to FIG. 1) of the first embodiment.

In the case of newly adding a warehouse (this is also hereinafter referred to as the “new warehouse”) to the current supply chain and performing simulation upon simulating a supply chain, the new dividing policy 1101 sets a new dividing policy, selects one dividing method among the plurality of dividing methods according to the new dividing policy, and divides the new warehouse. Meanwhile, the item lineup list 1102 represents the list of items handled in the new warehouse upon newly establishing a warehouse.

While the simulation data dividing unit 1103 divides the simulation input data 109 into a plurality of simulation divided input data in the same manner as the simulation data dividing unit 110 according to the first embodiment, at such time, the simulation data dividing unit 1103 performs the foregoing division based on the new dividing policy 1101 and the item lineup list 1102. Note that, in the second embodiment also, the simulation data dividing unit 1103 divides the simulation input data 109 into the simulation divided input data 111, the simulation divided input data 112, and the simulation divided input data 113.

### (2-2) Operational Example of Supply Chain Simulation System

The supply chain simulation system according to the second embodiment is configured as described above, and the differences in the operation thereof in comparison to the first embodiment are now mainly explained.

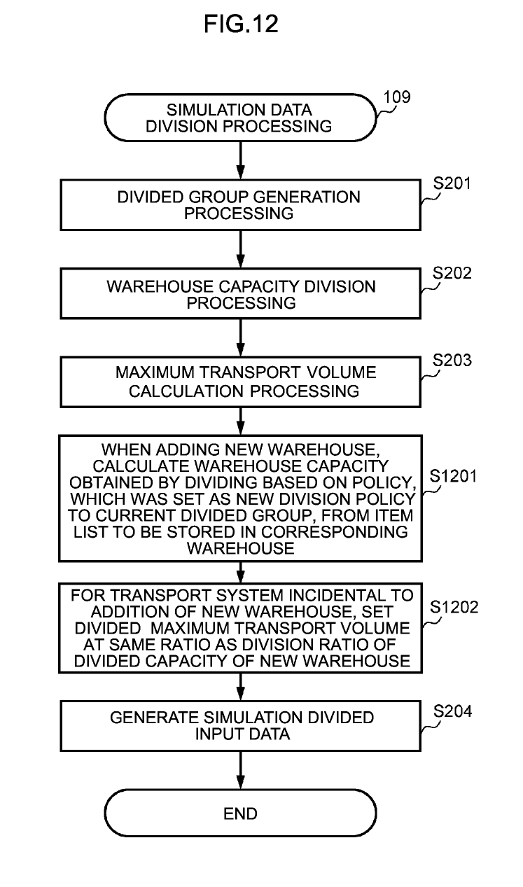

FIG. 12 shows an example of the simulation data division processing in the second embodiment. The simulation data division processing is executed by the simulation data dividing unit 1103.

The simulation data division processing in the second embodiment differs from the simulation data division processing (refer to FIG. 7) according to the first embodiment in that following steps S1201, 1202 are added between step S203 and step S204. Note that, because steps S201 to S203, S204 in the second embodiment are the same as those of the first embodiment, the explanation regarding steps S201 to S203, S204 is omitted.

Foremost, in step S1201, the simulation data dividing unit 1103 divides the capacity of the new warehouse. Specifically, when the new warehouse is to be simulated, the simulation data dividing unit 1103 uses the item lineup list 1102 that is handled in the new warehouse, calculates the allocation capacity of the new warehouse according to the new dividing policy 1101, and allocates the capacity to each divided group.

In this embodiment, the following three types of policies are illustrated as the new dividing policy 1101. The first policy, for example, is to apply, to the newly established warehouse, the mean value of the respective warehouses calculated based on the total amount of inventory of all existing warehouses regarding the newly established warehouse (corresponds to “total inventory quantity of all warehouses” described later). The second policy, for example, is to apply, to the new warehouse, the capacity allocation ratio of warehouses existing in a region that is geographically close to the newly established warehouse regarding the newly established warehouse (corresponds to “copy of other warehouses” described later). The third policy, for example, is to apply a fixed value, which was arbitrarily set, to the new warehouse.

Next, in step S1202, the simulation data dividing unit 1103 adds a transport system incidental to the increase of the new warehouse, and divides the transport volume. The simulation data dividing unit 1103 divides the transport volume by applying the capacity division ratio determines for the new warehouse to the transport volume of the transport system.

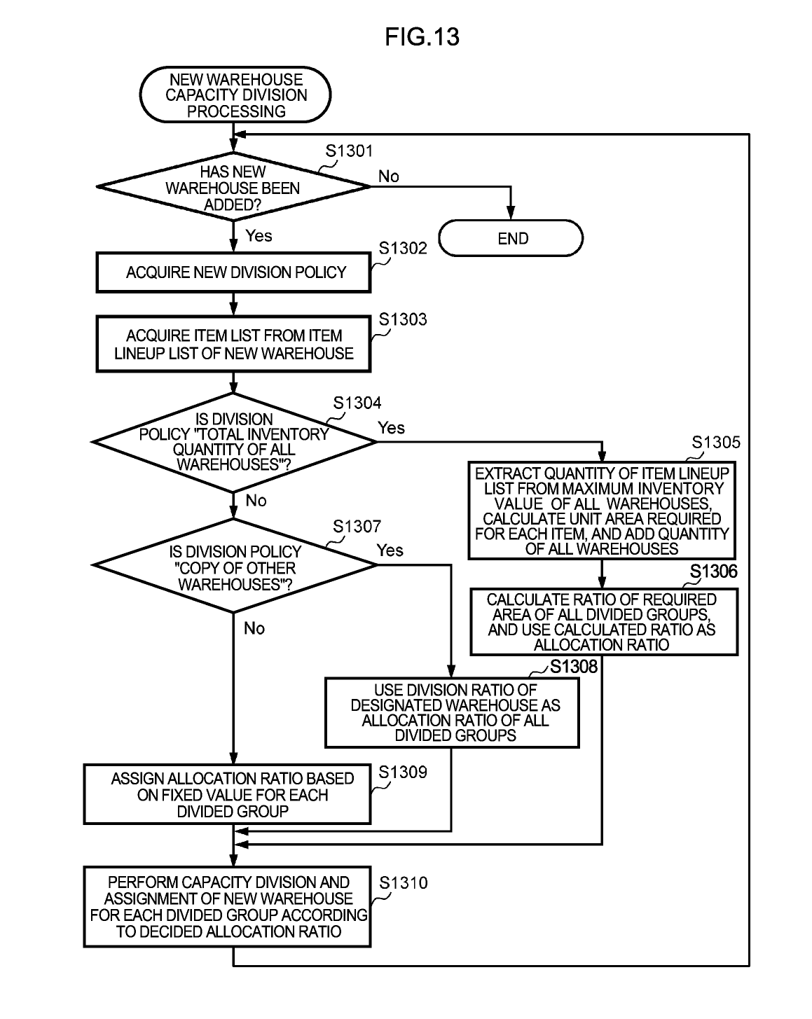

FIG. 13 shows an example of the new warehouse capacity division processing. In this new warehouse capacity division processing, the simulation data dividing unit 1103 foremost determines whether or not there is a remaining new warehouse (step S1301). As a result of the foregoing determination, the simulation data dividing unit 1103 performs processing to the new warehouse from step S1302 described below when there is a remaining new warehouse, and ends this processing when there is no remaining new warehouse because the capacity allocation ratios of all new warehouses have been determined.

The simulation data dividing unit 1103 acquires the first policy, the second policy and the third policy described above from the new dividing policy 1101 as the policies upon dividing the new warehouse (step S1302), and concurrently uses these policies. Next, the simulation data dividing unit 1103 refers to the item lineup list 1102, and acquires the list of items handled in the new warehouse (step S1303).

Next, the simulation data dividing unit 1103 determines whether or not the policy acquired in step S1302 is the “total inventory quantity of all warehouses (first policy)” (step S1304), and executes the dividing method using the total inventory quantity of all warehouses from step S1305 as follows upon obtaining a positive result, and determines whether or not it is a different policy from step S1307 described later upon obtaining a negative result.

In step S1305, the simulation data dividing unit 1103 executes the dividing method based on the “total inventory quantity of all warehouses” according to the determination in step S1304. Specifically, the simulation data dividing unit 1103 acquires items listed in the item lineup list from the inventory maximum value for each item of all warehouses to be simulated, calculates the required area, and adds the required areas of all warehouses. Furthermore, the simulation data dividing unit 1103 totals, for each divided group, the required areas added for each item, and calculates the required areas for each divided group of the target items in all warehouses.

Next, in step S1306, the simulation data dividing unit 1103 calculates the ratio of the required areas for each divided group obtained in step S1305, uses the result as the capacity allocation ratio of the new warehouse, and executes step S1310 described later.

Next, in step S1307, when the policy is not the “total inventory quantity of all warehouses” in the determination of step S1304, the simulation data dividing unit 1103 determines whether the set policy is the “copy of other warehouses (second policy)”. When the policy is the “copy of other warehouses (second policy)”, the simulation data dividing unit 1103 performs the processing corresponding to the copy of other warehouses; that is, applies the capacity allocation ratio of the existing warehouse that is geographically close to the new warehouse (step S1308). Meanwhile, when the policy is not the “copy of other warehouses (second policy)”, the simulation data dividing unit 1103 applies the foregoing third policy, and assigns the capacity allocation ratio at a fixed value (step S1309).

Step S1308 is the processing that is performed when the policy determined in step S1307 described above is the “copy of other warehouses (second policy)”. The simulation data dividing unit 1103 acquires the division ratio from the warehouse designated in the new dividing policy 1101, uses the result as the allocation ratio of each divided group of the new warehouse, and executes step S1310.

Meanwhile, step S1309 is the processing that is performed when the policy determined in step S1307 described above is not the “copy of other warehouses (second policy)”. The simulation data dividing unit 1103 uses the division ration designated in the new dividing policy 1101, uses the result as the allocation ratio of each divided group of the new warehouse, and executes step S1310.

In step S1310, the simulation data dividing unit 1103 uses the capacity allocation ratio of each divided group of the warehouse respectively obtained in steps S1306, S1308, S1309 described above, and assigns the capacity of the new warehouse for each divided group according to the foregoing ratio. After the processing, the simulation data dividing unit 1103 returns to and performs the processing of step S1301 described above. Because the subsequent processing is the same as the first embodiment, the explanation thereof is omitted.

### (2-3) Effect of this Embodiment

As a result of performing the foregoing process, in addition to the effects yielded in the first embodiment described above, no inventory performance will exist upon adding a new warehouse, but division simulation can be performed using a more favorable capacity allocation ratio regarding the new warehouse.

As described above, when a new warehouse is added separately from a plurality of warehouses, the simulation data dividing unit 1103 creates a plurality of simulation divided input data 111, 112, 113 so that the area of the new warehouse is distributed to each divided group based on the area ratio selected among (1) the area ratio (first policy) of each of the divided groups calculated in relation to the plurality of warehouses, (2) the area ratio of each divided group corresponding to another warehouse in a region that is geographically close the new warehouse among the plurality of warehouses, and (3) the pre-set area ratio.

When the division simulation is performed in the foregoing manner, it is possible to obtain a simulation result of the supply chain under more favorable conditions and with favorable simulation accuracy.

### (2-4) Modified Examples

When a new warehouse is added separately from a plurality of warehouses, the simulation data dividing unit 1103 creates three simulation divided input data 111, 112, 113 so that the maximum shipping volume of the new transport system (or existing transport system) used for loading and unloading products to and from the new warehouse is distributed to each divided group based on the area ratio selected among (1) the area ratio (first policy) of each of the divided groups calculated in relation to the plurality of warehouses, (2) the area ratio (second policy) of each divided group corresponding to another warehouse in a region that is geographically close the new warehouse among the plurality of warehouses, and/or (3) the pre-set area ratio (third policy).

When the division simulation is performed in the foregoing manner, it is possible to obtain a simulation result of the supply chain under more favorable conditions and with favorable simulation accuracy.

### (3) Other Embodiments

The foregoing embodiments are exemplifications for explaining the present invention, and the present invention is not limited to such embodiments. The present invention may be implemented in various modes so as long as such implementation does not deviate from the subject matter of the invention. For example, while the foregoing embodiments sequentially explaining the processing of various programs, there is no need to specifically follow such sequence. Accordingly, so as long there is no inconsistency in the processing results, the order of processing may be exchanged or the processing may be performed in parallel.

### INDUSTRIAL APPLICABILITY

The present invention can be broadly applied to a supply chain simulation system in the field of supply chain simulation.

### REFERENCE SIGNS LIST

108 . . . input data creation unit, 110 . . . simulation data dividing unit, 118 . . . simulation result aggregation unit, 120 . . . result display unit.

1. A supply chain simulation system which performs simulation of a supply chain in which products of a plurality of items are each transported by a plurality of transport systems via a plurality of warehouses, comprising:
a simulation data dividing unit which sets each divided group by classifying the products of the plurality of items according to whether or not a distribution channel matches for each of the products of the plurality of items, calculates transport-related information of each of the divided groups based on an allocation ratio calculated for each of the divided groups, and creates a plurality of simulation divided input data obtained by consolidating and classifying, based on the transport-related information of each of the divided groups, simulation input data related to the products of the plurality of items for each item in which the transport-related information of each of the divided groups are closely related to each other;
a plurality of simulators which individually execute division simulation based on the plurality of simulation divided input data;
a simulation result aggregation unit which generates simulation aggregate result data by aggregating a plurality of simulation division execution result data representing results of simulations respectively performed by the plurality of simulators; and
a result display unit which displays an overall result of the simulation based on the simulation aggregate result data.

2. The supply chain simulation system according to claim 1,
wherein the simulation data dividing unit calculates a total area required for housing all of the items belonging to each of the divided groups by calculating a unit area required for housing each of the items belonging to each of the divided groups and calculating a maximum inventory performance for each of the items belonging to each of the divided groups, and creates the plurality of simulation divided input data so as to distribute a gross area of the plurality of warehouses to each of the divided groups based on the area ratio of each of the divided groups calculated according to the total area required for each of the divided groups.

3. The supply chain simulation system according to claim 1,
wherein the simulation data dividing unit calculates a total weight required for transporting each of the items belonging to each of the divided groups by calculating a unit weight required for housing each of the items belonging to each of the divided groups and calculating a maximum transport volume for each of the items belonging to each of the divided groups, and creates the plurality of simulation divided input data so as to distribute a maximum transport volume of the plurality of transport systems to each of the divided groups based on a ratio of a required transport volume of each of the divided groups calculated according to the total weight required for each of the divided groups.

4. The supply chain simulation system according to claim 2,
wherein, when a new warehouse is added separately from the plurality of warehouses, the simulation data dividing unit creates the plurality of simulation divided input data so as to distribute an area of the new warehouse to each of the divided groups based on the area ratio of each of the divided groups which was previously calculated in relation to the plurality of warehouses.

5. The supply chain simulation system according to claim 2,
wherein, when a new warehouse is added separately from the plurality of warehouses, the simulation data dividing unit creates the plurality of simulation divided input data so as to distribute an area of the new warehouse to each of the divided groups based on the area ratio of each of the divided groups corresponding to another warehouse of a region that is geographically close to the new warehouse among the plurality of warehouses.

6. The supply chain simulation system according to claim 2,
wherein, when a new warehouse is added separately from the plurality of warehouses, the simulation data dividing unit creates the plurality of simulation divided input data so as to distribute an area of the new warehouse to each of the divided groups based on a pre-set area ratio.

7. The supply chain simulation system according to claim 4,
wherein, when a new warehouse is added separately from the plurality of warehouses, the simulation data dividing unit creates the plurality of simulation divided input data so as to distribute an area of the new warehouse to each of the divided groups based on an area ratio selected among the area ratio of each of the divided groups which was previously calculated in relation to the plurality of warehouses, the area ratio of each of the divided groups corresponding to another warehouse of a region that is geographically close to the new warehouse among the plurality of warehouses, and the pre-set area ratio.

8. The supply chain simulation system according to claim 4,
wherein, when a new warehouse is added separately from the plurality of warehouses, the simulation data dividing unit creates the plurality of simulation divided input data so as to distribute a maximum shipping volume of a new transport system to load and unload items to and from the new warehouse to each of the divided groups based on the area ratio of each of the divided groups which was previously calculated in relation to the plurality of warehouses, the area ratio of each of the divided groups corresponding to another warehouse of a region that is geographically close to the new warehouse among the plurality of warehouses, or the pre-set area ratio.

9. A supply chain simulation method of performing simulation of a supply chain in which products of a plurality of items are each transported by a plurality of transport systems via a plurality of warehouses, comprising:
a simulation data division step in which a computer sets each divided group by classifying the products of the plurality of items according to whether or not a distribution channel matches for each of the products of the plurality of items, calculates transport-related information of each of the divided groups based on an allocation ratio calculated for each of the divided groups, and creates a plurality of simulation divided input data obtained by consolidating and classifying, based on the transport-related information of each of the divided groups, simulation input data related to the products of the plurality of items for each item in which the transport-related information of each of the divided groups are closely related to each other;
a simulation step in which a plurality of simulators individually execute division simulation based on the plurality of simulation divided input data;
a simulation result aggregation step in which the computer generates simulation aggregate result data by aggregating a plurality of simulation division execution result data representing results of simulations respectively performed by the plurality of simulators; and
a result display step in which the computer displays an overall result of the simulation based on the simulation aggregate result data.

10. The supply chain simulation method according to claim 9,
wherein, in the simulation data division step, the computer calculates a total area required for housing all of the items belonging to each of the divided groups by calculating a unit area required for housing each of the items belonging to each of the divided groups and calculating a maximum inventory performance for each of the items belonging to each of the divided groups, and creates the plurality of simulation divided input data so as to distribute a gross area of the plurality of warehouses to each of the divided groups based on the area ratio of each of the divided groups calculated according to the total area required for each of the divided groups.

11. The supply chain simulation method according to claim 9,
wherein, in the simulation data division step, the computer calculates a total weight required for transporting each of the items belonging to each of the divided groups by calculating a unit weight required for housing each of the items belonging to each of the divided groups and calculating a maximum transport volume for each of the items belonging to each of the divided groups, and creates the plurality of simulation divided input data so as to distribute a maximum transport volume of the plurality of transport systems to each of the divided groups based on a ratio of a required transport volume of each of the divided groups calculated according to the total weight required for each of the divided groups.

12. The supply chain simulation method according to claim 10,
wherein, in the simulation data division step, when a new warehouse is added separately from the plurality of warehouses, the computer creates the plurality of simulation divided input data so as to distribute an area of the new warehouse to each of the divided groups based on the area ratio of each of the divided groups which was previously calculated in relation to the plurality of warehouses.

13. The supply chain simulation method according to claim 10,
wherein, in the simulation data division step, when a new warehouse is added separately from the plurality of warehouses, the computer creates the plurality of simulation divided input data so as to distribute an area of the new warehouse to each of the divided groups based on the area ratio of each of the divided groups corresponding to another warehouse of a region that is geographically close to the new warehouse among the plurality of warehouses.

14. The supply chain simulation method according to claim 10,
wherein, in the simulation data division step, when a new warehouse is added separately from the plurality of warehouses, the computer creates the plurality of simulation divided input data so as to distribute an area of the new warehouse to each of the divided groups based on a pre-set area ratio.

15. The supply chain simulation method according to claim 12,
wherein, in the simulation data division step, when a new warehouse is added separately from the plurality of warehouses, the computer creates the plurality of simulation divided input data so as to distribute an area of the new warehouse to each of the divided groups based on an area ratio selected among the area ratio of each of the divided groups which was previously calculated in relation to the plurality of warehouses, the area ratio of each of the divided groups corresponding to another warehouse of a region that is geographically close to the new warehouse among the plurality of warehouses, and the pre-set area ratio.
